(19) United States
(12) Patent Application Publication
(10) Pub. No.: US 2016/0130771 A1
(43) Pub. Date: May 12, 2016

(54) METHOD FOR OPERATING AN ATTACHED COMPACTOR, STORAGE MEDIUM AND ATTACHED COMPACTOR

(71) Applicant: MTS MASCHINENTECHNIK SCHRODE AG, Hayingen (DE)

(72) Inventors: Ulrike Nohlen, Hohenstein (DE); Rainer Schrode, Zwiefalten (DE); Manuel Splittgerber, Muensingen (DE)

(73) Assignee: MTS MASCHINENTECHNIK SCHRODE AG, Hayingen (DE)

(21) Appl. No.: 14/766,411

(22) PCT Filed: Jan. 7, 2014
(86) PCT No.: PCT/EP2014/050128

§ 371 Date: Aug. 6, 2015

(30) Foreign Application Priority Data
Jan. 10, 2013 (DE) 10 2013 200 274.2

(51) Int. Cl. E01C 19/38; B60K 35/00; E02D 3/046; E02F 1/00; E02F 9/20

(52) U.S. Cl. CPC E01C 19/38; E02F 1/00; E02F 9/2025; E02F 9/2058; E02D 3/046; B60K 35/00

(57) ABSTRACT

In a method for spatially fixed operation of an attached compactor having a vibrating lower section it is proposed such that an end of a possible compaction be indicated by a corresponding signal.

### CROSS-REFERENCE TO RELATED APPLICATIONS

The present application is a National Stage of International Patent Application No. PCT/EP2014/050128, filed on Jan. 7, 2014, which claims priority to and all the benefits of German Patent Application No. 10 2013 200 274.2, filed on Jan. 10, 2013, both of which are hereby expressly incorporated herein by reference in their entirety.

### BACKGROUND OF THE INVENTION

1. Field of the Invention

The invention relates to a method for operating an attached compactor according to the preamble of claim 1, as well as a storage medium and an attached compactor according to the preambles of the coordinate independent Claims.

2. Description of the Related Art

Attached compactors are known, for example, from DE 10 2009 018 490 A1 and DE 10 2008 006 211 A1. They are used as an auxiliary device for excavators, in particular in trench and pipeline construction. In conjunction with quick coupling devices and turning heads, as an inexpensive attachment device they offer a significant potential in terms of cost-saving measures and for increasing work safety, because people are no longer needed for compacting work in trenches and ditches.

DE 203 07 434 U1 discloses an attached compactor having a metering device that is not defined in greater detail, for determining the compaction state of the ground in order to be able to check whether the processed soil already has the necessary degree of compaction, or must be re-worked. U.S. Pat. No. 5,695,298 does not describe an attached compactor, but rather a roller compactor. For such a roller compactor, it is proposed that the excitation of a vibrating body be controlled such that a harmonic vibration component, having a frequency that is half of the excitation frequency, is in a predefined relation to the overall vibration. Ultimately, with this roller compactor, the vibration is thus determined as a function of a variable characterizing a harmonic distortion.

### SUMMARY OF THE INVENTION

The object of the present invention is to provide a method that enables an economical operation of an attached compactor having a vibrating lower part.

The present invention overcomes the disadvantages in the related art in a method for operating an attached compactor having a vibrating lower part wherein completion of the compaction is indicated by a corresponding signal. In addition, the present invention is directed toward a storage medium wherein a computer program is stored on said medium and is programmed to execute this method.

More specifically, it is proposed that in stationary, i.e. in fixed, operation of an attached compactor having a vibrating lower part, a completion of a possible compaction is indicated by a corresponding signal. The method according to the invention thus allows the user to identify that point in time at which a further operation of the attached compactor results in no, or no substantial, further compaction of the soil. The invention can thus be summarized with the keyword “compaction completion identification.” In that said point in time is identified, an unnecessary, and thus uneconomical, operation of the attached compactor can be avoided. The soil compaction is thus accelerated, because it is possible to move more quickly to the next position where the attached compactor is to be operated. Furthermore, the service life of the attached compactor is increased, because an unnecessary operation thereof is avoided, and because an operation thereof, resulting in excess wear, on soil that has already been compacted to a maximum extent is avoided.

One possible design for the invention makes use of the knowledge that a variable, which can characterize a compaction state, e.g. a harmonic distortion, or a variable that characterizes this, or corresponds thereto, is then substantially constant on a temporal basis when the state of the soil has achieved a maximum possible compaction, such that this variable, however, likewise varies when the compaction continues to vary. It is thus proposed, according to the invention, that the temporal variation of this variable, which characterizes, or corresponds to, a compaction state or a harmonic distortion, respectively, be monitored, in that the value thereof is compared with a limit value (which may be close to zero). When the temporal variation of the variable reaches the limit value, it may be assumed that a state of a maximum compaction has been reached at the current position where the attached compactor is in operation, such that a corresponding action can be initiated. This action can amount to the attached compactor being automatically switched off, but it can also consist of the machine operator being provided with a corresponding indication thereof.

In one embodiment, a method for the operation of an attached compactor having a vibrating lower part is proposed, comprising the following steps:

a. recording a first variable, which characterizes the vibrations of the vibrating lower part;

b. determining a second variable, which can characterize a compaction state from the variable recorded in step a.

c. determining a third variable, which characterizes a temporal variation of the second variable determined in step b.

d. comparing the third variable determined in step c with a limit value; and

e. initiating an action, depending on the results of the comparison.

The term “harmonic distortion” specified in the introduction is not to be understood as limiting thereby. Any variable that varies with an increasing degree of compaction, and no longer varies when the degree of compaction also no longer increases, can be used as a variable that characterizes the compaction state, or harmonic distortion, respectively. These variables include, aside from the classic “harmonic distortion,” a “total harmonic distortion” or suchlike as well, for example, wherein there is an entire series of definitions, differing in details in the professional field, for both the harmonic distortion as well as the total harmonic distortion. Furthermore, it is to be understood that one of the fundamental aspects of the method according to the invention is the fact that compaction with an attached compactor having a vibrating lower part, in the form of a compacting plate, for example, occurs in a spatially stationary manner, thus, a first surface, or the contents of the spatial region lying thereunder, is first compacted until a maximum compaction has been achieved, and then a subsequent surface, or the contents of the spatial region lying thereunder, is compacted, and so on.

It is furthermore worth noting that the method according to the invention can also be used when the load with which the supporting vehicle (e.g. an excavator arm of an excavator) pushes the attached compactor against the soil is not known. The reason for this that, although the absolute value, e.g. the harmonic distortion, is dependent on said load, this is not the case, however, for its temporal variation with the increasing extent of compaction.

In still another embodiment of the method, it is proposed that in step d of the method, in which the third variable, determined in step c, is compared with a limit value, this third variable is compared with a limit value and then in step e, when the limit value has been reached and/or the third variable falls below the limit value, a signal is generated that can be perceived by an operator. This development is useful, in particular, when a harmonic distortion or a total harmonic distortion is used as the second variable. The limit value can only be slightly above or below zero in practice, because a temporal variation from zero means that no further compaction will be obtained. The generation of a signal that can be perceived by the operator allows the operator to freely decide if, for some reason, the attached compactor should then be continued to be operated, for example, for it to be simply moved to the next compaction site without shutting it off. It is understood that then, when an inverted variable is used for the third variable, rather than testing to see if the variable falls below the limit value, an exceeding of the limit value must be tested for.

The signal can be perceived acoustically, visually and/or in a tactile manner thereby. In the simplest case, the signal is simply a light signal generated, for example, by a lamp, or a sound signal generated, for example, by a load speaker, or a vibratory signal on an operating handle with which the operator controls the attached compactor. The signal can be generated directly on the attached compactor thereby, or in a cab on the supporting vehicle to which the attached compactor is attached. In the latter case it is conceivable that a wireless data transfer from the attached compactor to the supporting vehicle occurs, by radio signals or infrared, for example.

It is furthermore proposed that then, when the limit value has not been reached, a current frequency of the vibrating lower part is determined from the first variable and indicated to the operator.

According to the invention, the method can include the additional supplementary steps: comparing the second variable determined in step b with a limit value; suspending the processing of steps c to e as long as the second variable is less than the limit value. This further development can be summarized with the keyword “idle detection.”

An idling state exists then when the attached compactor is in operation, that is, the eccentric drive is powered, but the vibrating lower part does not rest on the compacted soil. This is the case, for example, during the moving of the attached compactor from one compaction surface to the next. When the attached compactor is raised, it is clear that no compaction occurs, such that the variable determined in step c of the method according to the invention must be, at least substantially, equal to zero. In order to prevent coming to the conclusion as a result, that a supposed completion of the compaction has been reached, this state is detected with the additional method steps proposed here, and the indication of a supposed completion of compaction is suppressed.

This is based on the physical knowledge that in the idling state the vibrations of the vibrating lower part substantially correspond to the harmonic vibration of the eccentric drive, thus exhibiting hardly any harmonics. A harmonic distortion or a total harmonic distortion in this case is quite large. An idling can be reliably detected using this further development according to the invention, as is the case, for example, when the attached compactor is raised away from the soil for cleaning purposes. Here as well it is to be understood that then, when an inverse variable is used for the third variable, rather than testing to see if the variable has fallen below a limit value, an exceeding of the limit value is to be tested for.

The second variable can be determined in a particularly simple manner using a Fourier analysis.

In still another possible embodiment, the invention is distinguished in that the attached compactor has a power generator for supplying at least the sensor, which is powered, at least indirectly, by a drive motor for the eccentric drive. A power generator of this type can be a classic generator, for example, which is coupled to a shaft of the hydraulic drive motor. The use of a so-called “energy harvester” is also an option, however, which generates power from the vibrations of the vibrating lower part.

### BRIEF DESCRIPTION OF THE DRAWINGS

Other advantages of the invention will be readily appreciated as the same becomes better understood by reference to the following detailed description when considered in connection with the accompanying drawings, wherein:

FIG. 1 is a side view of an attached compactor and an excavator;

FIG. 2 is a diagram, in which the amplitudes of a fundamental vibration and two harmonic vibrations of a vibrating lower part in the form of a compactor plate of the attached compactor from FIG. 1 are plotted over time; and

FIG. 3 is a flow chart for a method for operating the attached compactor from FIG. 1.

### DETAILED DESCRIPTION OF THE INVENTION

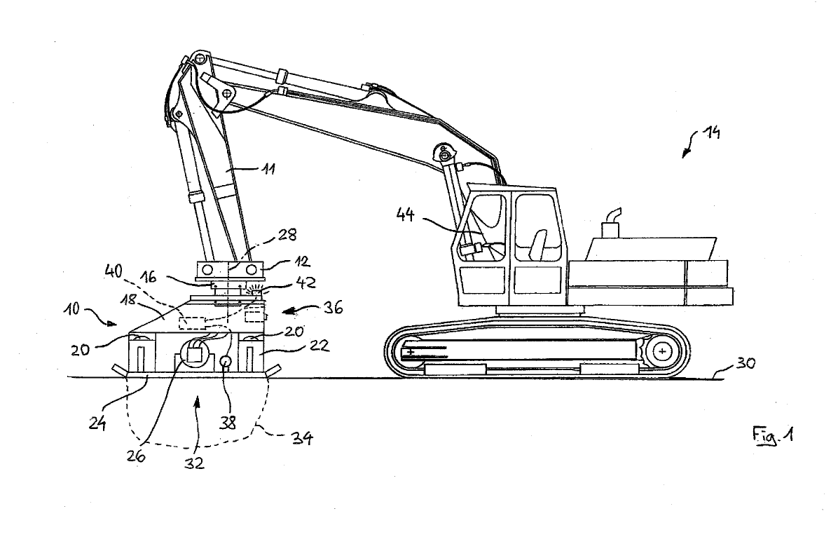

In FIG. 1, an attached compactor is generally indicated at 10. It is connected to an arm 11 of an excavator 14 via a hydraulic quick coupling device 12. The attached compactor 10 includes a turning device 16, beneath the quick coupler 12 in FIG. 1. The underside thereof is connected to an upper part 18, which is connected to a lower part 22 via elastic coupling elements 20.

The lower part 22 includes, in turn, a vibrating lower part in the form of a compactor plate 24, on which an eccentric device 26 is disposed. This includes a hydraulic drive motor, not shown in detail, which is connected, via a shaft, running perpendicular to the drawing plane of the Figure, to a mass disposed eccentrically in relation to the shaft axis. Furthermore, the eccentric device 26 has a generator, which provides electrical power for the components of the attached compactor 10.

The attached compactor is mechanically connected not only to the arm 11 of the excavator 14 via the quick coupler 12, but also to the hydraulic supply lines of the excavator 14. On one hand, the turning device 16, and on the other hand, the eccentric device 26, are controlled via these lines. When the attached compactor 10 is in operation, the upper part 18 and the lower part 22 can be rotated by the turning device 16 about an axis of rotation 28 that is orthogonal to the plane of the compactor plate 24. A sinusoidal force component, orthogonal to the plane of the compactor plate 24, is generated on the compactor plate 24 by operation of the eccentric device 26. When the operator starts up the attached compactor 10, and presses it against the soil 30 that is to be compacted at a specific location 32 via the excavator arm 11, the spatial region 34 lying beneath the compactor plate 24 is compacted.

The attached compactor 10 depicted in FIG. 1 can be used, in particular, in canalization, in earth-moving, as well as with back filling. It is particularly important in these situations to ensure that a certain compaction of the spatial region 34 is achieved. It is frequently the case thereby that a maximum possible compaction is desired. Soils are frequently used in these situations that cannot be used, for example, for the construction of a road surface, such as soils that are not frost-proof and are less resistant to sliding, in particular fine grained and mixed grained soils, as well as rock fills.

In order to indicate to the operator of the excavator 14 functioning as the supporting vehicle that an at least substantially, maximum possible compaction state has been obtained in the spatial region 34, the attached compactor 10 has a device that indicates to the operator when said maximum possible compaction has been obtained. This device, as a whole, has the reference numeral 36 in FIG. 1.

It includes a sensor 38, which is rigidly coupled to the compactor plate 24, and with which the amplitudes and frequency of the vibrations of the compactor plate 24 can be detected in a direction orthogonal to the plane of the compactor plate 24. The device 36 further includes an electronic processing device 40, disposed in the region of the upper part 18 of the attached compactor 10 in the present embodiment, and which receives the signal from the sensor 38, and processes said signal in accordance with a method described below in detail (in an embodiment that is not shown, the processing device 40 is disposed in the lower part (22). For this, the processing device 40 has a storage medium on which a computer program is stored, which is programmed for executing said method. Electrical power is supplied to the processing device 40 from the generator for the eccentric device 26 mentioned above. The device 36 also has a signal lamp 42, attached to the upper surface of the upper part 18, and connected to the processing device 40.

In one embodiment that is not shown, only the sensor 38 for the device is disposed on the attached compactor 10. The processing device 40, on the other hand, is disposed directly in the cab 44 of the excavator 14, as is also the case with the signal lamp 42. The signal from the sensor 38 is transmitted to the processing device 40 in this case in a wireless manner.

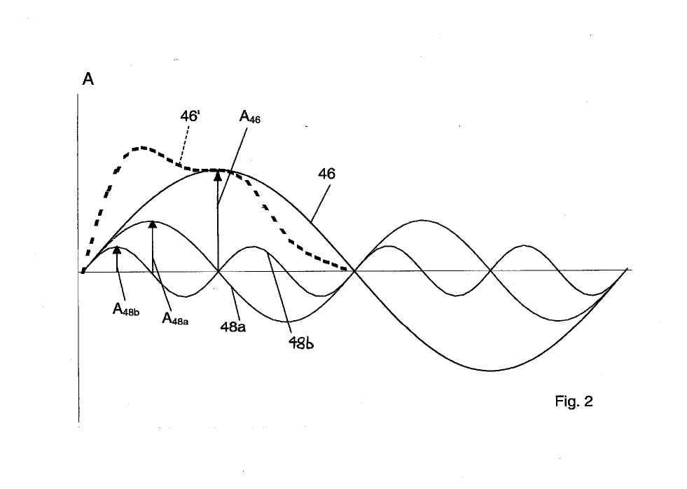

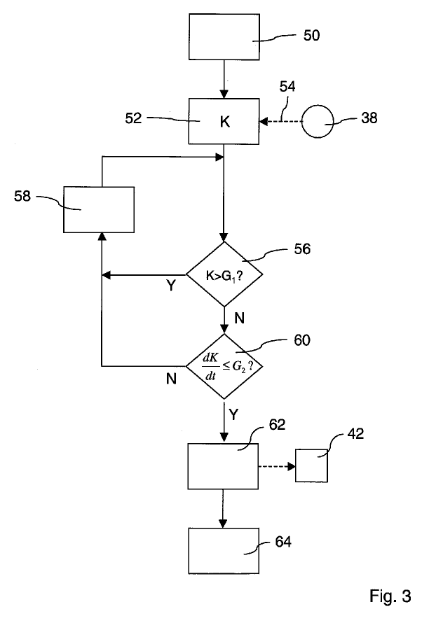

The method, according to which the device 36 functions, and which is executed in the processing device 40 in accordance with the computer program stored therein, shall now be explained in detail with reference to the attached FIGS. 2 and 3.

The sinusoidal course of the fundamental vibration of the compactor plate 24 is shown in FIG. 2, with the reference numeral 46, for a full period thereof. The ordinate indicates the amplitude A thereby, the abscissa indicates time. This fundamental vibration is present when the attached compactor 10 is operated without a load, that is, when it is not pressed against the soil 30 with the excavator arm 11. An amplitude of the fundamental vibration 46 is indicated in FIG. 2 by A₄₆.

When the attached compactor 10 is pressed against the soil 30 by the excavator arm 11, in order to compact the spatial region 34 lying beneath the compactor plate 24, the vibrational behavior of the compactor plate 24 varies. Instead of the harmonic fundamental vibration 46, there is now a distorted fundamental vibration 46′, which is depicted, for one half of a period, in an exemplary manner in FIG. 2, by a broken line. This distorted fundamental vibration 46′ can, for example, can be divided in turn, by use of a Fourier analysis, into the harmonic fundamental vibration 46 and numerous harmonic vibrations 48i (i=a, b, c, . . . ). This is shown in an exemplary manner in FIG. 2 for the first two harmonic vibrations 48a and 48b. The harmonic vibration 48a has an amplitude A₄₈ₐ, the harmonic vibration 48b has an amplitude A_{48b}.

The physical circumstances specified above are employed in the processing device 40 for executing a method, which shall now be explained in reference to FIG. 3. The method starts in a start Block 50. In Block 52 a harmonic distortion K is determined from the signal 54 from the sensor 38. The harmonic distortion K is the quotient of the sums of the amplitudes A, of the harmonics of the vibration of the compactor plate 24 and the amplitude A of the fundamental vibration, according to the following equation:

$$K = \sqrt{\frac{\sum {A}_{i}^{2}}{{A}^{2}}}$$

For the example depicted in FIG. 2, the following equation is obtained:

$$K = \sqrt{\frac{{A}_{48 a}^{2} + {A}_{48 b}^{2}}{{A}_{46}^{2}}}$$

Instead of the harmonic distortion K, any other variable could be determined in Block 52 that varies with the compaction state of the spatial region 34. This also includes, by way of example, a total harmonic distortion.

The determined harmonic distortion K is compared in Block 56 with a limit value G1. If the harmonic distortion K is less than the limit value G1, the program jumps to Block 58. If the harmonic distortion K is greater than or equal to the limit value G1, the program jumps to Block 60. With the comparison in Block 56, it is detected whether the attached compactor 10 is pressed by the excavator arm 11 against the soil 30, or whether it is raised above the soil 30, thus in a so-called “idling operation.” This occurs, for example, when the attached compactor 10 is moved from the position 32 after successful compaction to an adjacent position 32, or when it is being cleaned.

If the attached compactor 10 does not rest against the soil 30 with the compactor plate 24, then for all practical purposes, there are no relevant harmonics 48i, or the amplitudes Ai thereof are only very small. This results in a very small harmonic distortion K, which is detected by the comparison in Block 56. The limit value G1 is selected such that there is a greater probability that the compactor is in an idling operation. It may, for example, lie in the range of 0.2. In this case, simply the current vibrational frequency of the compactor plate 24 is indicated in Block 58 by a corresponding display device.

If the compactor is not in idling operation, an actual checking of whether the maximum compaction of the spatial region 34 has been obtained occurs in Block 60. For this, the temporal division dK/dt of the harmonic distortion K, that is, the temporal variation of the harmonic distortion, is first determined. This temporal variation dK/dt is then compared with a limit value G₂. If the temporal variation dK/dt is greater than the limit value, the program jumps to Block 58, referred to above. If the temporal variation dK/dt is less than or equal to the limit value G₂, however, it may be assumed that the maximum possible compaction of the spatial region 34 has been achieved, and this is visually indicated to the operator in Block 62 by a corresponding activation of the signal lamp 42. Additionally, or alternatively, an acoustic signal may be emitted, by a signal sound, for example, or a tactile signal may be emitted, by a vibrating of a control element in the cab 44, for example. The method ends in Block 64.

The comparison in Block 60 results in the following: the absolute value of the harmonic distortion K is directly dependent on the current compaction state of the spatial region 34, when the pressure force form the attached compactor 10 by the excavator arm 11 against the soil 30 at the position 32 is constant. Because this compaction state varies during the compaction, the harmonic distortion K also varies. If a state of an at least substantially maximum compaction of the spatial region 34 has been obtained, the density of the soil within the spatial region 34 no longer varies, and thus the harmonic distortion K also no longer varies. In this case the temporal derivation dK/dt of the harmonic distortion K thus approaches zero. This is detected by the comparison with the limit value G₂, which for practical purposes is selected such that it is close to zero.

The invention has been described in an illustrative manner. It is to be understood that the terminology which has been used is intended to be in the nature of words of description rather than of limitation. Many modifications and variations of the invention are possible in light of the above teachings. Therefore, within the scope of the appended claims, the invention may be practiced other than as specifically described.

1. A method for operating an attached compactor having a vibrating lower part, wherein a completion of a possible compaction is indicated by a corresponding signal.

2. The method as set forth in claim 1, further including the steps of: a. recording a first variable (46′), characterizing the vibrations of the lower part; b. determining a second variable (K), which can characterize a compaction state, from the first variable (46′) recorded in step a; c. determining a third variable (dK/dt), which characterizes a temporal variation of the second variable (K) determined in step b; d. comparing the third variable (dK/dt) determined in step c with a limit value (G2); and e. initiation of an action, depending on the results of the comparison.

3. The method as set forth in claim 2, wherein in step d the third variable (dK/dt) is compared with a limit value (G2), and then, in step e, when the limit value (G2) has been reached, and/or the value of the variable is less than the limit value, a signal is generated that can be perceived by an operator.

4. The method as set forth in claim 1, wherein the signal can be perceived acoustically, visually and/or in a tactile manner.

5. The method as set forth in claim 3, wherein at least then, when the limit value (G2) has not been reached, a current frequency of the compactor plate is determined from the first variable (46′) and indicated to the operator.

6. The method as set forth in claim 2, wherein it additionally comprises the following step: comparing the second variable (K) determined in step b with a limit value (G1); suspending the processing of steps c to e as long as the second variable (K) is less than the limit value (G1).

7. The method as set forth in claim 2, wherein the second variable (K) is determined employing a Fourier analysis.

8. A storage medium, wherein a computer program is stored thereon, which is programmed to execute a method for operating an attached compactor having a vibrating lower part, wherein a completion of a possible compaction is indicated by a corresponding signal.

9. An attached compactor for coupling to a supporting vehicle, in particular an excavator, having an eccentric drive and a vibrating lower part, wherein said compactor has a sensor, which records a variable (46′) characterizing the vibrations of the lower part, and conducts a corresponding signal to a processing device, which processes the signal indicating the completion of the compactor.

10. The attached compactor as set forth in claim 9, wherein said compactor has a power generator for supplying at least the sensor, which is powered, at least indirectly, by a hydraulic drive motor, in particular that of the eccentric drive, and/or has an electrical connection for connecting to a power supply of the supporting vehicle.

11. The attached compactor as set forth in claim 9, wherein said compactor has a wireless signal transmission device, which transmits the signal from the sensor to a supporting vehicle-side processing device, or transmits a signal from the processing device to a supporting vehicle-side display device.
